(19) United States
(12) Patent Application Publication
(10) Pub. No.: US 2023/0217945 A1
(43) Pub. Date: Jul. 13, 2023

(54) ANIMAL FAT MIMIC FROM PLANT SOURCE

(71) Applicant: Cargill, Incorporated, Wayzata, MN (US)

(72) Inventors: Wesley B. GRIIFFIN, Goddard, KS (US); Tasha HERMES, Maple Grove, MN (US); Trent PEMBLE, Wayzata, MN (US); Summer STEEPLES, Valley Center, KS (US)

(73) Assignee: Cargill, Incorporated, Wayzata, MN (US)

(21) Appl. No.: 17/996,638

(22) PCT Filed: Apr. 21, 2021
(86) PCT No.: PCT/US21/28334

§ 371 Date: Oct. 20, 2022

Related U.S. Application Data
(60) Provisional application No. 63/013,154, filed on Apr. 21, 2020.

(51) Int. Cl. A23D 9/05; C11B 7/00; A23J 3/14; A23J 3/22

(52) U.S. Cl. CPC A23D 9/05; C11B 7/0075; A23J 3/14; A23J 3/227

(57) ABSTRACT

A particulate solid fat composition comprising coconut oil is prepared by a method comprising heating a fat composition comprising coconut oil, cooling the melted fat composition with stirring to provide a substantially uniform solid fat composition, and chopping the solid fat by a food cutting device under chilling conditions at a temperature low enough to form a a substantially uniform particulate solid fat composition wherein at least 90% of the particles have a particle size of from 1.5 mm to 26 mm. The substantially uniform particulate solid fat composition is substantially compositionally uniform, or is substantially visually uniform, and/or is substantially uniform in color. This particulate solid fat composition is mixed with a hydrated plant protein composition under chilling conditions at a temperature low enough to maintain the particulate nature of the solid fat composition to form an animal meat mimic.

### FIELD

The present invention relates to animal fat mimics prepared from plant sources.

### BACKGROUND

Consumers increasingly desire protein choices that are alternatives to animal meat protein for a variety of reasons. At the same time, many consumers enjoy the flavors and textures that are uniquely provide by meats obtained from animals. For this reason, a number of companies have striven to provide plant-based meat substitutes that replicate the experience of cooking and eating meat.

Examples of plant-based meat substitute products include the Impossible Burger from Impossible Foods, The Beyond Burger from Beyond Meat, and Ultimate Beefless Burger from Gardein. These and other products are discussed, for example, at https://www.healthline.com/nutrition/vegan-meat-substitutes#section4, which states that the Beyond Burger is made from pea protein, canola oil, coconut oil, potato starch and other ingredients.

U.S. Pat. No. 9,700,067 to Fraser et.al and assigned to Impossible Foods describes a ground beef-like food product comprising a heme-containing protein, plant proteins, and additional compounds, wherein cooking the ground beef-like food product results in the production of at least two volatile compounds which have a beef-associated aroma. Particular flavor precursors or compositions are described, including, for example, yeast extract, vegetable oil, corn oil, soybean oil, palm fruit oil, palm kernel oil, safflower oil, flaxseed oil, rice bran oil, cottonseed oil, olive oil, canola oil, sunflower oil, coconut oil, mango oil, or an algal oil. See, e.g., column 2, lines 55-59. Formulations of replica burgers comprising coconut oil are described in the Examples.

Likewise, extruded meat substitute compositions are described in WO 2017/046659 that comprise one or more sources of plant protein, one or more sources of lipid, one or more sources of carbohydrate, and water, wherein the one or more sources of carbohydrate may in some embodiments comprise fruit, fruit powder or chia seed extract, or any combination of any two or more thereof. In this composition, the sources of lipid may comprise a plant fat or oil, such as coconut, corn, cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

Edible oils have been used as vehicles to add supplements, nutraceuticals, or nutritive ingredients to ground meat or processed meat or game meat through a fat emulsion component. See, e.g., WO 2012/094397 to Ervin et. al.

### SUMMARY

It has been found that meat substitute products often fall short of the desired organoleptic experience because they lack one or more of the visual and textural characteristics of the animal meat it is intended to mimic The interplay between the protein components and the fat components of the animal meat is particularly difficult to present when using non-meat sourced ingredients. It has been discovered that an effective animal fat mimic (e.g. a beef fat mimic) can be prepared by careful selection of the plant based fat source and the processing steps carried out to prepare the plant based fat in a format suitable for combining with a protein source in a manner that provides a pleasing animal meat mimic

In an aspect, a particulate solid fat composition comprising coconut oil is prepared by a process comprising heating a fat composition comprising coconut oil that is solid at a temperature of 20° C. to a temperature sufficient to melt all fatty acid solids in the composition to form a melted fat composition, cooling the melted fat composition to provide a substantially uniform solid fat composition, and chopping the substantially uniform solid fat composition by a food cutting device under chilling conditions at a temperature low enough to form a substantially uniform particulate solid fat composition wherein at least 90% of the particles have a particle size of from 1.5 mm to 25.4 mm. For purposes of the present discussion, a substantially uniform particulate solid fat composition is a composition that is substantially compositionally uniform; or that is substantially visually uniform; and/or that is substantially uniform in color.

In an aspect, the animal meat mimic is prepared by mixing a plant protein composition with water, and optionally additionally with oil, to form a hydrated plant protein composition. The hydrated plant protein composition and the particulate solid fat composition are mixed under chilling conditions at a temperature low enough to maintain the particulate nature of the solid fat composition to form an animal meat mimic

Because the particulate solid fat composition has been prepared by melting, solidifying and chopping, the resulting particles are substantially uniform in composition, visually, and/or in color. This in turn provides a predictable raw material affording manufacturing reliability, and a final product exhibiting a consistent eating experience that is organoleptically pleasing. By incorporating the particulate solid fat composition in a plant protein matrix, the fat particles can operate to disrupt the plant protein matrix by melting during cooking, thereby giving an animal protein-like texture with a mouthfeel corresponding to that of meat.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the embodiments serve to explain the principles of the invention. A brief description of the drawings is as follows:

FIG. 1 is a photograph of a particulate solid fat composition as described herein.

FIG. 2 is a series of photographs of individual particles from the composition of FIG. 1 (ruler in photographs measures in inches). The individual particles are non-limiting examples of particles sizes ranging from a larger sized particle (A) to medium (B) and smaller sized particles (C, D).

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

In an aspect, the fat composition comprises from about 50 to 100% by weight coconut oil. In an aspect, the fat composition comprises from about 60 to 100% by weight coconut oil. In an aspect, the fat composition comprises from about 70 to 100% by weight coconut oil. In an aspect, the fat composition comprises from about 80 to 100% by weight coconut oil. In an aspect, the fat composition comprises from about 90 to 100% by weight coconut oil. In an aspect, the fat composition comprises from about 95 to 100% by weight coconut oil. In an aspect, the fat composition comprises only coconut oil.

In an aspect, the fat composition comprises from about 50 to 100% by weight coconut oil and further comprises an oil selected from cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

In an aspect, the fat composition comprises one or more oils selected from sunflower, canola or palm oil.

In an aspect, the fat composition comprises one or more additional ingredients selected from: colorant, preservative, emulsifier, solvent, fiber, hydrocolloids and water.

In an aspect, the fat composition comprises oils or additional ingredients in addition to coconut oil such that the fat composition is solid at a temperature of 23° C. In an aspect, the fat composition comprises components in addition to coconut oil such that the fat composition is solid at a temperature of 20° C. and melts at a temperature of 21° C. In an aspect, the fat composition comprises components in addition to coconut oil such that the fat composition is solid at a temperature of 21° C. and melts at a temperature of 22° C. In an aspect, the fat composition comprises components in addition to coconut oil such that the fat composition is solid at a temperature of 24° C. In an aspect, the fat composition comprises components in addition to coconut oil such that the fat composition is solid at a temperature of 26° C.

In an aspect of the present process, the fat composition comprising coconut oil is heated to a temperature sufficient to melt all fatty acid solids in the composition to form a melted fat composition. It has been found that compositions melted in this matter advantageously will resolidify upon cooling with stirring to form substantially uniform solid fat compositions, that in turn may be chopped to provide particulate solid fat compositions that are substantially compositionally uniform, or that are substantially visually uniform, and/or that are substantially uniform in color. In an aspect, the fat composition is melted completely so that all crystal forms are eliminated to a degree to prevent nucleation to form a crystal lattice that would lead to non-uniform solidification of the fat composition. The temperature required to melt a given composition comprising components in addition to coconut oil may be confirmed by conducting a Differential Scanning calorimetry analysis of crystallization curves to verify melting of fat solids, or in an aspect of all crystalline forms, without overheating in an amount to degrade an adverse amount of any of the components of the fat composition.

In an aspect, the fat composition comprising coconut oil is heated to a composition temperature of at least about 30° C. In an aspect, the fat composition comprising coconut oil is heated to a composition temperature of at least about 30° C. and held at this temperature for a time of at least about 30 seconds. In an aspect, the fat composition comprising coconut oil is heated to a composition temperature of at least about 30° C. and held at this temperature for a time of at least about 3 minutes. In an aspect, the fat composition comprising coconut oil is heated to a composition temperature of from about 30° C. to about 45° C. and held at this temperature for a time of at least about 30 seconds. In an aspect, the fat composition comprising coconut oil is heated to a composition temperature of from about 30° C. to about 45° C. and held at this temperature for a time of at least about 3 minutes.

It has been discovered that fat compositions comprising coconut oil may exhibit excellent high temperature shelf life. In an aspect, such fat compositions can be maintained at a temperature of from about 30° C. to about 45° C. for up to about four weeks without degradation or other adverse effects that would render the fat compositions comprising coconut oil unsuitable for food use. This high temperature shelf life is important, because manufacturing quantities of fat compositions comprising coconut oil (a tote container has a capacity of 275 gallons of oil) can take up to 72 hours to completely melt. Due to this shelf life, the fat compositions comprising coconut oil may advantageously be stored in a manufacturing facility at a temperature ready for on demand preparation of the particulate solid fat composition to be mixed with a hydrated plant protein composition to form an animal meat mimic

The melted fat composition is cooled with stirring to provide a solid fat composition that is further processed in later steps to provide a particulate solid fat composition that is substantially compositionally uniform; or that is substantially visually uniform; and/or that is substantially uniform in color.

In an aspect, the melted fat composition is cooled with stirring to provide a solid fat composition that is further processed in later steps to provide a substantially compositionally uniform particulate solid fat composition, wherein substantial compositional uniformity is determined by conducting a chemical analysis of five samples of 10 g size taken randomly from the material, wherein at least four of the composition samples vary no more than 15% from the average chemical composition of the five samples. In an aspect, at least four of the composition samples vary no more than 10% from the average chemical composition of the five samples. In an aspect, at least four of the composition samples vary no more than 5% from the average chemical composition of the five samples.

In an aspect, the melted fat composition is cooled with stirring to provide a solid fat composition that is further processed in later steps to provide a substantially visually uniform particulate solid fat composition, wherein substantial visual uniformity is determined by conducting a visual analysis of 100 solid fat composition particles to determine whether there are visible discontinuities in the compositionally uniform solid fat composition (such as bloom or other aggregation of fatty components) as determined by the human eye in a 10× magnification. A substantially visually uniform particulate solid fat composition is a composition wherein at least 85% of the visually inspected particles do not contain a visible discontinuity in the particle. In an aspect, at least 90% of the visually inspected particles do not contain a visible discontinuity in the particle. In an aspect, at least 95% of the visually inspected particles do not contain a visible discontinuity in the particle.

In an aspect, the melted fat composition is cooled with stirring to provide a solid fat composition that is further processed in later steps to provide a solid fat composition that is substantially uniform in color, wherein substantial color uniformity is determined by conducting an L*a*b* colorspace analysis of ten samples taken randomly from the material, wherein the Delta-E 2000 of at least eight of the ten samples are equal to or less than 1.0 from the average L*a*b* colorspace values of the ten samples. In an aspect, at least 9 of the ten samples are equal to or less than 1.0 from the average L*a*b* colorspace values of the ten samples. In the color uniformity analysis, the samples are measured by evaluating one mm diameter measuring areas of each the samples. Measurements can be made using a suitable color meter device, such as the CS-160 Luminance and Color Meter from Konica Minolta.

In an aspect, the melted fat composition is cooled with stirring to a temperature of from about 20° C. to about −15° C. In an aspect, the melted fat composition is cooled with stirring to a temperature of from about 20° C. to about 10° C. In an aspect, the melted fat composition is cooled with stirring to a temperature of from about 10° C. to about −15° C. In an aspect, the melted fat composition is cooled with stirring to a temperature of from about 10° C. to about 0° C. In an aspect, the melted fat composition is cooled with stirring to a temperature of from about 0° C. to about −15° C. In an aspect, the melted fat composition is cooled with stirring to a temperature of from about 0° C. to about −10° C. In an aspect, the melted fat composition is cooled with stirring to a temperature of from about −10° C. to about −15° C.

In an aspect, the melted fat composition is cooled at a cooling rate of from about 1° C./minute to about 5° C./minute.

The melted fat composition is cooled by any appropriate system, such as a jacketed reaction vessel or by addition of cold ingredients and/or by addition of dry ice (i.e. cooled and condensed carbon dioxide) or by addition of liquid nitrogen.

In an aspect, the melted fat composition is cooled while stirring with a stirring impeller that comprises blades that also perform a cutting function on the uniform solid fat composition. In this aspect, the melted fat composition is stirred during transition to a uniform solid fat composition and the step of chopping the compositionally uniform solid fat composition by a food cutting device under chilling conditions immediately begins in the same vessel.

The compositionally uniform solid fat composition is chopped by a food cutting device under chilling conditions at a temperature low enough to form a particulate solid fat composition.

In an aspect, the food cutting device is a food chopper. For purposes of the present description, a food chopper is a food cutter having a flat surface for receiving food to be cut, and one or more vertically movable cutting blades configured to chop the fat composition into particles.

In an aspect, the food cutting device is a bowl chopper. For purposes of the present description, a bowl chopper is a food cutter having a rotary bowl for receiving food to be cut, and one or more vertically oriented blades (also described as “knives” in the art) attached to a horizontally oriented rotary knife shaft. The rotary bowl rotates around a vertical axis, and the blades cut by rotation of the horizontally oriented rotary knife shaft. The blades are aligned relative to the internal wall or walls of the bowl such that they may chop and mix the food within the bowl. While the lateral position of the rotary knife shaft is substantially stationary, the bowl and the contents therein rotate relative to the blades whereby the contents are continuously moved against the blades as the bowl is rotating. In an aspect, the blades may be run in only a forward direction, or in an aspect run in both a forward direction and a reverse direction. Bowl choppers are commercially available, and are described, for example, in U.S. Pat. No. 5,996,917, the disclosure of which is incorporated herein by reference. The use of a bowl chopper in the present process is particularly advantageous, because it efficiently cuts the solid fat composition into particles with less generation of heat and less agglomeration of particles than would result from other devices that tend to lead to particle agglomeration, such as by grinding.

In an aspect, the food cutting device is a food processor. For purposes of the present description, a food processor is a food cutter having a food container for receiving food to be cut that is fitted with a hub configured to be coupled to a drive shaft of the food processor. One or more blades are rotatably coupled to the hub. In the case of the food processor, the blades are horizontally oriented, and the hub and drive shaft are generally vertically oriented. In an aspect, the blades may be run in only a forward direction, or in an aspect run in both a forward direction and a reverse direction. While the food processor may efficiently cut the solid fat composition into particles, it has been found that the orientation of the cutting motion of the blades tends to cause more agglomeration of the particles, and may require more cooling efforts or other anti-agglomeration steps to be taken in order to provide a particulate solid fat composition having the desired particle distribution. Food processors are commercially available, and are described, for example, in U.S. Pat. No. 7,054,348, the disclosure of which is incorporated herein by reference.

The compositionally uniform solid fat composition is maintained at a temperature low enough to form a particulate solid fat composition during the chopping step by any appropriate system, such as carrying out the chopping in a jacketed reaction vessel fitted with a chopping mechanism. In an aspect, the compositionally uniform solid fat composition is chilled by addition of dry ice (i.e. cooled and condensed carbon dioxide) before and/or during the chopping step. In an aspect, the compositionally uniform solid fat composition is chilled by addition of liquid nitrogen before and/or during the chopping step.

In an aspect, the compositionally uniform solid fat composition is maintained at a temperature less than 10° C. during the chopping step. In an aspect, the compositionally uniform solid fat composition is maintained at a temperature less than 0° C. during the chopping step. In an aspect, the compositionally uniform solid fat composition is maintained at a temperature less than −10° C. during the chopping step.

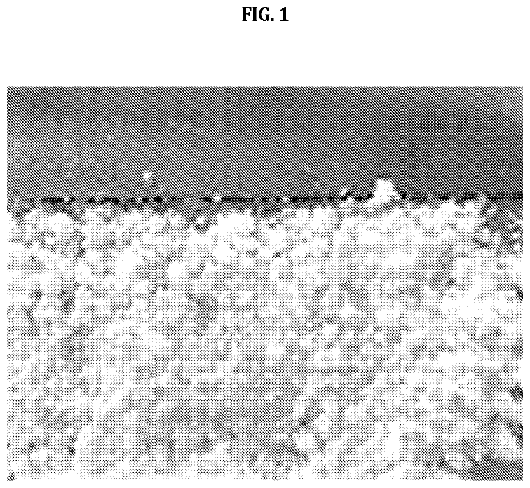

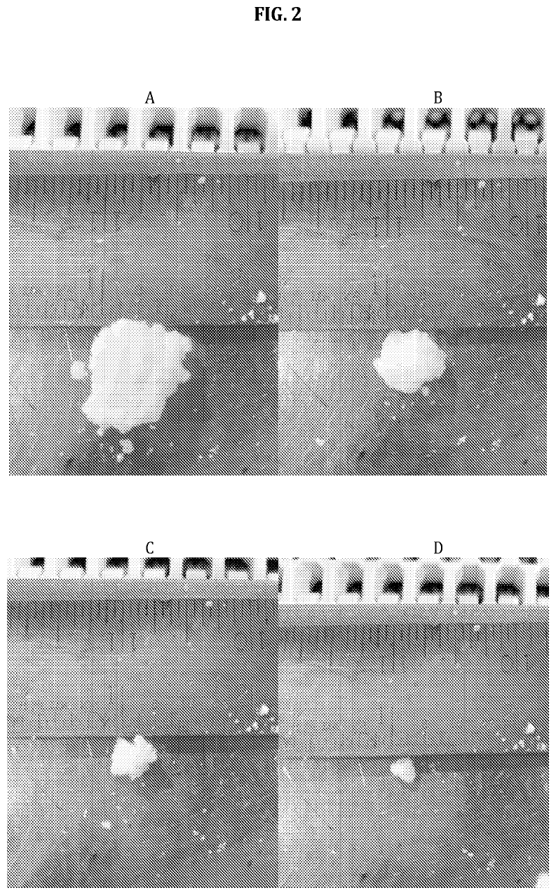

The particles prepared by this method have a particle size such that at least 90% of the particles have a particle size of from 1.5 mm to 26 mm. In an aspect, at least 90% of the particles have a particle size of from 3 mm to 13 mm. FIG. 1 is a photograph of a particulate solid fat composition as described above. FIG. 2 is a series of photographs of non-limiting examples of individual particles from the composition in FIG. 1.

In an aspect, at least 90% of the particles have a particle size of from 1.5 mm to 26 mm and at least 50% of the particles have a particle size of from 3 mm to 13 mm. In an aspect, at least 90% of the particles have a particle size of from 1.5 mm to 26 mm and at least 60% of the particles have a particle size of from 3 mm to 13 mm. In an aspect, at least 90% of the particles have a particle size of from 1.5 mm to 26 mm and at least 70% of the particles have a particle size of from 3 mm to 13 mm. In an aspect, at least 90% of the particles have a particle size of from 1.5 mm to 26 mm and at least 80% of the particles have a particle size of from 3 mm to 13 mm. In an aspect, at least 95% of the particles have a particle size of from 1.5 mm to 26 mm and at least 50% of the particles have a particle size of from 3 mm to 13 mm. In an aspect, at least 95% of the particles have a particle size of from 1.5 mm to 26 mm and at least 60% of the particles have a particle size of from 3 mm to 13 mm. In an aspect, at least 95% of the particles have a particle size of from 1.5 mm to 26 mm and at least 70% of the particles have a particle size of from 3 mm to 13 mm. In an aspect, at least 95% of the particles have a particle size of from 1.5 mm to 26 mm and at least 80% of the particles have a particle size of from 3 mm to 13 mm. In an aspect, at least 95% of the particles have a particle size of from 1.5 mm to 26 mm and at least 90% of the particles have a particle size of from 3 mm to 13 mm.

In an aspect, an anti-agglomerate may be applied to the particulate solid fat composition to prevent undue agglomeration of the particles before mixing with the protein composition. This aspect may be beneficial in the event that the particulate solid fat composition is to be stored in particle form for some time before mixing with the protein composition.

In an aspect, a process of preparing an animal meat mimic comprises mixing a plant protein composition with water to form a hydrated plant protein composition and mixing the hydrated plant protein composition with the particulate solid fat composition as described herein under chilling conditions at a temperature low enough to maintain the particulate nature of the solid fat composition to form an animal meat mimic.

In an aspect, the plant protein used in the present process may be selected from one or more of legume, alfalfa, chia, clover, pea, chickpea, cow pea, earth pea, sweet pea, pigeon pea, bean, broad bean, kidney bean, mung bean, navy bean, soy, lentil, lupin, mesquite, cocoa, carob, nut, peanut, almond, potato, gluten, cereal, maize, rice, wheat, wheat gluten, barley, sorghum, millet, oat, rye, triticale, buckwheat, fonio, quinoa, hemp, fungal, algal, or seaweed protein. In an aspect, the plant protein used in the present process may be selected from soy or pea protein.

In an aspect, the plant protein composition comprises plant protein in the form of a protein concentrate. In an aspect, the plant protein composition comprises plant protein in the form of a protein isolate.

In an aspect, the plant protein used in the present process is a powdered plant protein having a particle size range of from about 20 to about 300 μm. In an aspect, the plant protein used in the present process is a textured plant protein having a particle size range of from about 0.2 to about 20 mm.

The plant protein is hydrated by mixing the plant protein composition with water in any appropriate vessel, such as a mixer or blender. In an aspect, water is mixed with the plant protein composition in a water:(protein composition) weight ratio of from about 2:1 to about 4:1. In an aspect, water is mixed with the plant protein composition in a water:(protein composition) weight ratio of about 3:1.

In an aspect, the hydrated plant protein composition comprises an additional ingredient selected from flavorant, colorant, preservative (i.e. an ingredient to prevent or retard micro growth and/or spoilage), fiber, vitamins, minerals, and binders (hydrocolloids).

In an aspect, the hydrated plant protein composition comprises flavor ingredients selected to mimic the flavor of beef. In an aspect, the hydrated plant protein composition comprises flavor ingredients selected to mimic the flavor of pork. In an aspect, the hydrated plant protein composition comprises flavor ingredients selected to mimic the flavor of chicken. In an aspect, the hydrated plant protein composition comprises flavor ingredients selected to mimic the flavor of turkey.

In an aspect, any of the desired added ingredients may be added to the dry plant protein composition, or to the hydration water or both.

The hydrated plant protein composition is then mixed with the particulate solid fat composition as described herein under chilling conditions at a temperature low enough to maintain the particulate nature of the solid fat composition to prepare an animal meat mimic. In an aspect, hydrated plant protein composition is pre-chilled to a temperature of from about 0° C. to about 10° C. before mixing with the particulate solid fat composition. In an aspect, combined plant protein/particulate compositions mix is chilled by addition of dry ice (i.e. cooled and condensed carbon dioxide) before and/or during the mixing step. In an aspect, the combined plant protein/particulate compositions mix is chilled by addition of liquid nitrogen before and/or during the mixing step.

In an aspect, the combined plant protein/particulate compositions mix is maintained at a temperature less than 10° C. during the mixing step. In an aspect, the combined plant protein/particulate compositions mix is maintained at a temperature less than 0° C. during the mixing step. In an aspect, the combined plant protein/particulate compositions mix is maintained at a temperature of from about 0° C. to about 10° C. during the mixing step.

In an aspect, the particulate solid fat composition is mixed directly after formation of the particles with the protein composition. This aspect provides significant benefits in that the particles retain their uniformity and consistency, which is advantageous for effective distribution in the hydrated plant protein composition. In this aspect a further benefit is reduction of additive materials such as anti-agglomerates that may inhibit interaction of the fat with the protein composition as the final product is heated for consumption.

Mixing of the hydrated plant protein composition with the particulate solid fat composition may be carried out in the same or a different mixing device as used to mix the plant protein with water to form a hydrated plant protein composition. Any suitable mixing device may be used to prepare mixed product, such as a blender. In an aspect, the mixing device uses an impeller such as a paddle blender, to prepare the animal meat mimic product. The mixer in an aspect does not impart excess pressure to the mixture, as this would result in an overly dense product that does not meet texture expectations. In an aspect, the mixing is not carried out in an extruder exerting 1.5 MPa or more of pressure.

In an aspect, the hydrated plant protein composition with the particulate solid fat composition by a food cutting device as described above. In an aspect, the steps of the cooling the melted fat composition with stirring, chopping the compositionally uniform solid fat composition by a food cutting device, and mixing the particulate solid fat composition with the hydrated plant protein composition are carried out using the same food cutting device. In an aspect, the preparation of the animal meat mimic is carried out by cooling the melted fat composition with stirring in a food cutting device, chopping the compositionally uniform solid fat composition in the same food cutting device, and adding the hydrated plant protein composition to the thus prepared uniform solid fat composition and mixing the respective compositions in the same food cutting device.

In an aspect, the animal meat mimic is a ground meat mimic product. In an aspect, the animal meat mimic is a ground beef mimic product. In an aspect, the animal meat mimic is a ground pork mimic product. In an aspect, the animal meat mimic is a ground chicken mimic product. In an aspect, the animal meat mimic is a ground turkey mimic product. In an aspect, the animal meat mimic is a seafood mimic product. Non-limiting examples of a seafood mimic product include: a fish mimic product, a ground fish mimic product, a shrimp mimic product, a crab mimic product, a lobster mimic product, or a shellfish mimic product.

In an aspect, the animal meat mimic product is provided in a bulk format. In an aspect, the product is provided in overwrapped trays. This package type features air permeable overwrap with animal meat mimic product placed on an absorbent pad in a foam or plastic tray, packaging. In an aspect, the product is provided in a case ready tray, wherein the animal meat mimic product is packaged and sealed at the plant in a plastic-lidded package. In an aspect, the product is provided in chubs, wherein the animal meat mimic product is packaged in a tube-like package. In an aspect, the animal meat mimic product is packaged in any such format in sizes of 1 lb., 2 lb., 3 lb., 5 lb. and 10 lb.

The animal meat mimic product may be used to prepare any final food products that one might prepare using a ground meat product, such as burgers, meat loaf, meatballs, sausages, and the like. Additionally, the animal meat mimic product may be mixed with actual animal products, such as ground beef, ground turkey, ground chicken, ground fish, and the like to reduce the amount of animal product in a given food Animal protein products containing a substantial amount of the present animal meat mimic product (e.g. from 20 to 80%, or from 30-60%, or from 35-55% plant protein based on all protein in the product) advantageously provides a different protein content distribution from animal sourced meat products. Additionally, vegetable sourced proteins may be less expensive and less resource demanding during production than animal sourced proteins, thereby reducing the overall cost of the final product without sacrificing flavor.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A process of preparing a particulate solid fat composition comprising coconut oil comprising:
heating a fat composition comprising coconut oil that is solid at a temperature of 20° C. to a temperature sufficient to melt all fatty acid solids in the composition to form a melted fat composition;
cooling the melted fat composition with stirring to provide a substantially uniform solid fat composition; and
chopping the substantially uniform solid fat composition by a food cutting device under chilling conditions at a temperature low enough to form a substantially uniform particulate solid fat composition wherein at least 90% of the particles have a particle size of from 1.5 mm to 26 mm; wherein the substantially uniform particulate solid fat composition is substantially compositionally uniform, or is substantially visually uniform, and/or is substantially uniform in color.

2. The process of claim 1, wherein at least 90% of the particles have a particle size of from 1.5 mm to 26 mm.

3. The process of claim 1, wherein at least 90% of the particles have a particle size of from 1.5 mm to 26 mm and at least 50% of the particles have a particle size of from 3 mm to 13 mm.

4. The process of claim 1 , wherein the fat composition comprises from about 50 to 100% by weight coconut oil. or wherein the fat

5. The process of claim 1, wherein the fat composition comprises from about 50 to 100% by weight coconut oil and further comprises an oil selected from cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

6. The process of claim 1, wherein the fat composition further comprises one or more oils selected from sunflower, canola or palm oil.

7. The process of claim 1, wherein the fat composition comprises an additional ingredient selected from flavorant, colorant, preservative, emulsifier solvent, fiber, hydrocolloids and water.

8. The process of any one of claim 1, wherein the fat composition comprises components in addition to coconut oil such that the fat composition is solid at a temperature of 23° C.

9. The process of claim 1, wherein the fat composition is heated to a composition temperature of at least 30° C.

10. The process of claim 1, wherein the melted fat composition is cooled with stirring to a temperature of from about 20° C. to about −15° C.

11. The process of claim 1, wherein the food cutting device is a food chopper; or wherein the food cutting device is a bowl chopper; or wherein the food cutting device is a food processor.

12. The process of claim 1, wherein the compositionally uniform solid fat composition is chilled by addition of dry ice before and/or during the chopping step; or wherein the compositionally uniform solid fat composition is chilled by addition of liquid nitrogen before and/or during the chopping step.

13. The process of claim 1, wherein the compositionally uniform solid fat composition is maintained at a temperature less than 10° C. during the chopping step.

14. The process of claim 1, wherein the melted fat composition is cooled while stirring with a stirring impeller that comprises blades that also perform a cutting function on the uniform solid fat composition.

15. A particulate solid fat composition prepared the process of claim 1.

16. (canceled)

17. A process of preparing an animal meat mimic comprising:
mixing a plant protein composition with water to form a hydrated plant protein composition; and
mixing the hydrated plant protein composition with the particulate solid fat composition of claim 15 under chilling conditions at a temperature low enough to maintain the particulate nature of the solid fat composition to prepare an animal meat mimic.

18. The process of claim 17, wherein the plant protein is selected from the group consisting of legume, alfalfa, chia, clover, pea, chickpea, cow pea, earth pea, sweet pea, pigeon pea, bean, broad bean, kidney bean, mung bean, navy bean, soy, lentil, lupin, mesquite, cocoa, carob, nut, peanut, almond, potato, gluten, cereal, maize, rice, wheat, wheat gluten, barley, sorghum, millet, oat, rye, triticale, buckwheat, fonio, quinoa, hemp, fungal, algal, or seaweed protein, and mixtures thereof.

19. The process of claim 17, wherein the hydrated plant protein composition comprises flavor ingredients selected to mimic the flavor of beef; or wherein the hydrated plant protein composition comprises flavor ingredients selected to mimic the flavor of pork; or wherein the hydrated plant protein composition comprises flavor ingredients selected to mimic the flavor of chicken; or wherein the hydrated plant protein composition comprises flavor ingredients selected to mimic the flavor of turkey

20. The process of claim 17, wherein water is mixed with the dry plant protein in a water:(protein composition) weight ratio of from about 2:1 to about 4:1.

21. The process of claim 17, wherein the hydrated plant protein composition is pre-chilled to a temperature of from about 0° C. to about 10° C. before mixing with the particulate solid fat composition.

22-26. (canceled)
